(19) United States
(12) Patent Application Publication
(10) Pub. No.: US 2025/0335255 A1
(43) Pub. Date: Oct. 30, 2025

(54) SERVICE LEVEL OBJECTIVE-BASED REGULATOR

(71) Applicant: Oracle International Corporation, Redwood Shores, CA (US)

(72) Inventors: Rajesh Desai, Centreville, VA (US); Ben George, San Jose, CA (US); Kaustubh Manohar Fating, Pune (IN)

(73) Assignee: Oracle International Corporation, Redwood Shores, CA (US)

(21) Appl. No.: 18/646,680

(22) Filed: Apr. 25, 2024

(51) Int. Cl. G06F 9/50; G06F 9/48; G06F 12/02

(52) U.S. Cl. CPC G06F 9/5038; G06F 9/485; G06F 12/0253; G06F 2212/70

(57) ABSTRACT

Techniques are disclosed that enable a self-regulating process to meet a service level objective (SLO). In some embodiments, a self-regulating process is a background process comprising a regulator that receives background job requests and historical information related to the background process for evaluation to determine actions (e.g., speed up, slow down, or maintain the same speed), enabling the background process to adjust its pace gradually and smoothly even when encountering unexpected big changes in load.

### FIELD

The present disclosure generally relates to techniques for providing cloud infrastructure services. More specifically, techniques are disclosed that enable a self-regulating process to meet a service level objective (SLO).

### BACKGROUND

Cloud computing has become an important part of modern life. Cloud infrastructure services provided by a cloud service provider (CSP) to its customers include computer systems with millions of processes, including foreground and background processes, running, and working together seamlessly.

### BRIEF SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a method performed by one or more processors of a computing system. The method also includes obtaining requests to be processed, the requests being executed by one or more processing threads running in a background process for a cloud infrastructure service. The method also includes receiving historical information related to the background process for the cloud infrastructure service, the historical information comprising a performance distribution in background process. The method also includes evaluating feasibility to meet an objective for completing the background process based at least in part on the obtained requests and the historical information related to the background process. The method also includes determining an action to take for the background process based at least in part on the evaluation, the action being configured to effect gradual changes in the background process. The method also includes performing the action for the background process.

In one embodiment, the background process is a first operation being performed in parallel to a second operation performed by the cloud infrastructure service.

In yet another embodiment, the first operation performed in the background process is a garbage collection operation, and the second operation performed by the cloud infrastructure service is an object deletion operation.

In yet another embodiment, the performance distribution of the historical information comprises a moving average execution time of the requests by the one or more processing threads over a sliding window.

In yet another embodiment, the performance distribution of the historical information comprises a trend of changes in a moving average execution time of the requests by the one or more processing threads.

In yet another embodiment, the objective is an amount of time allowed for the background process to complete the requests assigned to the background process.

In yet another embodiment, the gradual changes in the background process are changes in an expected execution time for processing the requests to meet the objective, wherein the expected execution time is shorter than and close to the objective while minimum resources are used for the background process.

In yet another embodiment, the action is an increase, decrease or substantially the same in the expected execution time for processing the requests.

In various embodiments, a system is provided that includes one or more data processors and a non-transitory computer readable medium containing instructions which, when executed on the one or more data processors, cause the one or more data processors to perform part or all of one or more methods disclosed herein.

In various embodiments, a non-transitory computer-readable medium, storing computer-executable instructions which, when executed by one or more processors, cause the one or more processors of a computer system to perform one or more methods disclosed herein.

In various embodiments, a computer-program product, comprising computer program/instructions which, when executed by a processor, cause the processor to perform any of the methods disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

FIG. 1 is a simplified block diagram of a distributed environment 100 utilizing SLO-based regulators for background processes, according to certain embodiments.

FIG. 2 is a flowchart illustrating a generalized method for an SLO-based regulator, according to some embodiments.

FIG. 3 is a flowchart illustrating a method of evaluating latency distribution for a SLO-based regulator, according to some embodiments.

FIG. 4 is a flowchart illustrating a method of determining an action by an SLO-based regulator, according to some embodiments.

FIG. 5 is a block diagram illustrating one pattern for implementing a cloud infrastructure as a service system, according to at least one embodiment.

FIG. 6 is a block diagram illustrating another pattern for implementing a cloud infrastructure as a service system, according to at least one embodiment.

FIG. 7 is a block diagram illustrating another pattern for implementing a cloud infrastructure as a service system, according to at least one embodiment.

FIG. 8 is a block diagram illustrating another pattern for implementing a cloud infrastructure as a service system, according to at least one embodiment.

FIG. 9 is a block diagram illustrating an example computer system, according to at least one embodiment.

### DETAILED DESCRIPTION

In a cloud infrastructure service (e.g., a computer system), a foreground process and a background process may co-exist and each may try to perform as fast and efficiently as possible. However, since both the foreground and background processes may share the same underlying resources, the foreground process may experience a noisy neighbor problem before the background process is aware that it has affected the foreground process (and potentially needs to back off. Therefore, each process working as fast as possible in isolation may become counter-productive for the whole cloud infrastructure service.

For example, in a database system, a foreground process, such as a customer's request to read/write/update/delete an object, is desired to perform as fast as possible without minimum latency. When an object is deleted, it may be marked as deletion for garbage collection later without waiting for storage space to be freed up. The garbage collector, performing a background process, may identify the deleted objects and free up storage space for reuse. When a large number of objects are deleted, the background garbage collection may encounter a big increase in the load and try to speed up its process. Since both the foreground process and background process may share the same underlying resources (e.g., CPUs, memory, network, etc.), the sudden speed-up of the background garbage collection process may have an impact on the foreground database operation process.

However, to allow both the foreground process and the background process to be aware of each other to achieve the best overall performance for the computer system is complicated. Thus, there is a need to address these challenges and others.

The techniques disclosed herein enable a self-regulating process to meet a service level objective (also referred to as an SLO-based regulator). The self-regulating process may be a background process that works in tandem with a foreground process such that the background process can avoid big changes (i.e., engage in gradual changes or smooth transition) in its processing speed even when encountering unexpected big changes in load (e.g., number of job requests) while achieving its optimal performance. The background process refers to an operation (e.g., garbage collection or daemon thread), without requiring user intervention, performed in parallel to a foreground operation (e.g., compute operation or storage operation), interacting directly with a user, performed by a cloud infrastructure service.

Some examples of a background process may include garbage collection, as discussed above, and memory self-check process to scrub every entry in the memory device to detect any corruption and perform corrections accordingly.

A regulator for a background process (e.g., garbage collection performed by a garbage collector (GC) or memory/storage self-check) may have several inputs and generate an output as an action signal to the background process to speed up or accelerate (e.g., dispatching more GC threads, also referred to as lean-in or “lean in”), slow down (e.g., reducing number of GC threads, also referred to as back-off or “back off”), or keep the same pace (e.g., keeping the same number of GC threads, also referred to as stay-course or “stay course”). In some embodiments, one input of the regulator may be background job requests fetched by the regulator together with an indication of the number of remaining job requests. The second input may be a service level objective (SLO), or how far behind the background is compared to the SLO. A third input may be historical information for the dispatched background threads executing the background job requests. These inputs can be evaluated and analyzed together to determine appropriate action for the background process to take to optimize its performance.

The techniques disclosed herein for a SLO-based regulator may also apply to a foreground process or any process that likes to achieve a self-regulated and jitter-free process.

In some embodiments, regulators of different cloud services may communicate with each other through a regulator communication network to share their respective states, such as priorities and back-off requests to help each other make decision for action to take. Such communication may be useful when two or more regulators share infrastructure resources.

Embodiments of the present disclosure provide a number of advantages/benefits. The techniques disclosed in the present disclosure allow the background process to pace itself by evaluating the surrounding environment (e.g., background load, foreground load, priorities) and adjust/regulate itself accordingly, instead of blindly and passively reacting to the surrounding environment to become counterproductive. Additionally, the techniques having the visibility into the historical information (e.g., past ten fetches) can help anticipate potential problems (e.g., performance degradation reflected in latency trend) in the cloud infrastructure service (e.g., computing systems) and proactively adjust the background process to address beforehand.

Finally, the techniques are applicable to different types of background processes and distributed systems (e.g., multiple servers) since the regulator for each background process may not only communicate with its corresponding foreground process but also with other background processes. In other words, a regulator is not limited to its own context and can interact with other regulators within the cloud infrastructure, providing various services. Thus, both the foreground and background processes for various services can have better performance, save costly resources and bandwidth, and improve customer experience (i.e., meeting service level objectives).

### Service Level Objective (SLO)-Based Regulator

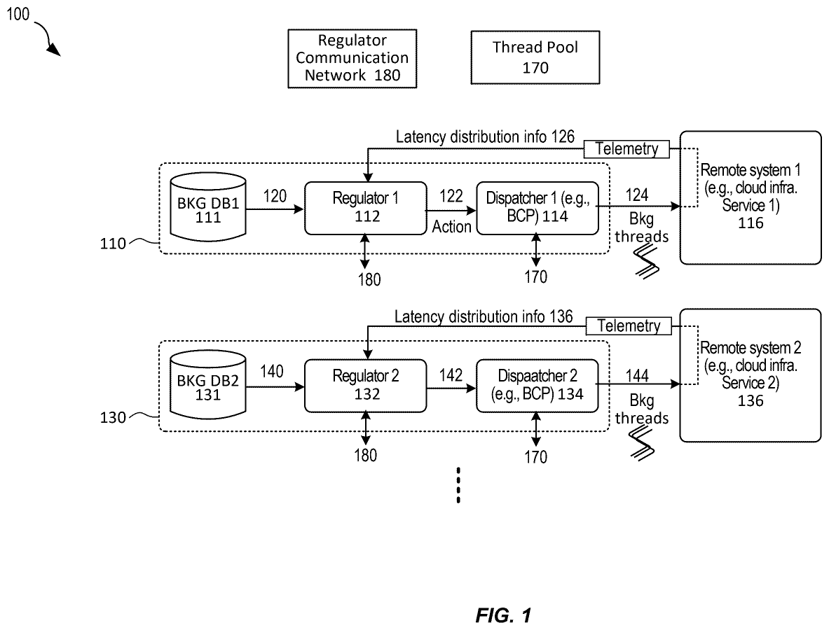

FIG. 1 is a simplified block diagram of a distributed environment 100 utilizing SLO-based regulators for background processes, according to certain embodiments. Distributed environment 100 depicted in FIG. 1 is merely an example and is not intended to unduly limit the scope of claimed embodiments. Many variations, alternatives, and modifications are possible. For example, in some implementations, distributed environment 100 may have more or fewer systems or components than those shown in FIG. 1, may combine two or more systems, or may have a different configuration or arrangement of systems. The systems, subsystems, and other components depicted in FIG. 1 may be implemented in software (e.g., code, instructions, program) executed by one or more processing units (e.g., processors, cores) of the respective systems, using hardware, or combinations thereof. The software may be stored on a non-transitory storage medium (e.g., on a memory device).

As shown in FIG. 1, the distributed environment 100 may include many background processes (110, 130, etc.), for example, garbage collection and memory/storage self-check, running in parallel. Each background process (e.g., 110) can include a background database (e.g., 111, BKG DB) containing background job requests, a regulator (e.g., 112), for regulating the pace of its associated background process (e.g., 110), and a dispatcher (e.g., 114), such as background control plane (BCP) for dispatching background processing threads (e.g., 124). Here, the terms, dispatcher and BCP, may be used interchangeably in this disclosure. In some embodiments, a dispatcher may include both background CP and background data plane (DP, now shown) that work together to dispatch background processing threads based on action signal from the regulator. Each background process may execute background job requests for a remote system (e.g., 116, 136, etc.), such as a cloud infrastructure service.

In some embodiments, the dispatchers (e.g., BCPs) (e.g., 114 and 134) of different background processes (e.g., 110, 130, etc.) may share a common thread pool 170, which include a number of processing threads provided by cloud infrastructure resources (e.g., compute, storage, etc.).

In FIG. 1, a regulator (e.g., 112) can estimate how much background work remains to be completed, and how fast its associated background process (e.g., 110) should proceed to achieve its optimal performance without causing an unwanted big swing in the background processing speed. The regulator may receive input information (e.g., 120) from BKG DB (e.g., 111), a feedback information (e.g., 126), such as latency distribution information, from the background threads (e.g., 124) executing the background job requests in cloud infrastructure service 1 (e.g., 116). Here, the terms, remote system and cloud infrastructure service, may be used interchangeably in this disclosure. In some embodiments, a regulator (e.g., 112) can also communicate to one or more other regulators (e.g., 132) through a regulator communication network 180.

In some embodiments, the input information (e.g., 120) from BKG DB may include, but is not limited to, job requests, backlog information about remaining background job requests to be processed (e.g., in terms of time) by the background process (e.g., 110) and historical information pertaining to previous requests processing (similar to the feedback information 126 and used if the latency distribution information is not available). For example, when a foreground process deletes objects, a garbage collection background process may initiate a background garbage collection request process, where the requests are stored in the BKG DB.

The backlog information may indicate how far behind the background process is from the SLO, such as the remaining epoch time and latency (if the feedback information 126 is not available). The service level objective (SLO) refers to the amount of time allowed for the background process to complete all the requests assigned to the background process. In other words, SLO is a performance goal in specific metrics, such as response time, agreed between a cloud service provider (CSP) and a customer. For example, the SLO is one day (i.e., 24 hours) and the elapsed time (Elapsed_Tme) of the background process is 5 hours. Thus, the background process still has 19 hours (i.e., remaining epoch time (referred to as Available_Time)) to complete all the remaining background job requests in the BKG DB to meet the SLO.

In certain embodiments, the background job requests in the BKG DB (e.g., 111) may be organized by time (referred to as epoch time in a computer system). For example, there may be several queues containing job requests that need to be fetched by the regulator (e.g., 112) and processed by the background process (e.g., 110) within the SLO (e.g., a day or 24 hours).

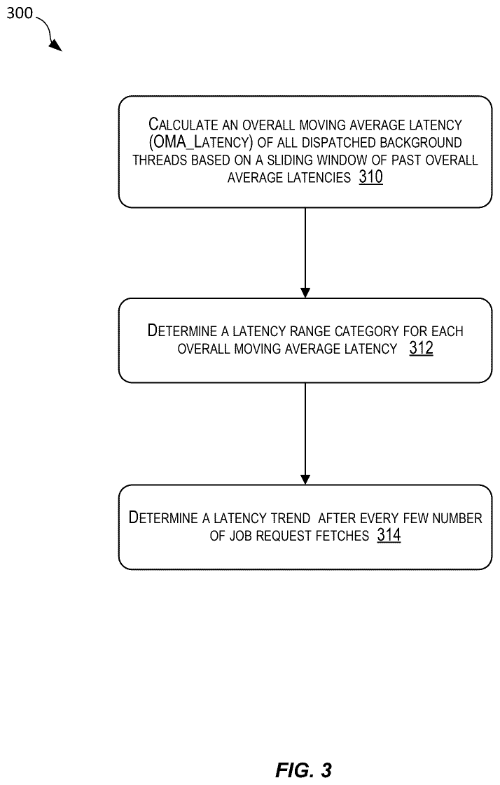

In some embodiments, the feedback information (e.g., 126) includes latency distribution information (also called performance distribution information), which comprises the historical information for the dispatched background threads (e.g., asynchronous worker threads, referred to as async worker threads) executing the background job requests, allowing the regulator to evaluate and figure out a moving average latency for the running threads and the trend of the latency distribution. For example, each running background thread may provide its average latency (i.e., the average time (or latency) for this thread to execute a job request), which is measured by observing the number of job requests processed by a thread over a defined time interval (e.g., 10 requests processed within 2,000 ms resulting in average latency 200 ms per request). The regulator can take the average latency information of all running threads to calculate an overall average latency (i.e., average execution time) to determine how much time is needed (referred to as TBD_Tme) to complete processing the remaining job requests in the BKG DB. Further details describing the average latency calculation and trend of latency distribution are described below in FIG. 3 and the accompanying description.

In certain embodiments, the latency distribution information may be in the form of percentage of job requests completed in a certain period of time, for example, 70% of job requests are completed in 2,000 ms.

Depending on whether the TBD_Time is longer/larger or shorter/smaller than the Available_Time, the regulator (e.g., regulator 1 112) can decide an action (e.g., lean-in, back-off, or stay course), and notify BCP (e.g., BCP 1 114) through an action signal (e.g., 122). A lean-in signal refers to an action to increase the dispatching rate (e.g., increase the number of dispatching background threads (i.e., async worker threads)) when the background process is behind the SLO (i.e., TBD_Time is larger than the Available_Time). A back-off signal refers to an action to reduce the dispatching rate (e.g., reduce the number of background async worker threads or delay fetching background job requests) when the background process is ahead of the SLO (i.e., TBD_Time is smaller than the Available_Time). A stay-course signal refers to an action to continue the same dispatching rate when the background process is likely to meet the SLO (i.e., TBD_Time is close to the Available_Time). As a result, the BCP 1 (e.g., 114) may dispatch a number of threads (e.g., 3), each capable of executing a configurable number of job requests (e.g., 10˜20). In other words, lean-in action speeds up the background process. Back-off action slows down the background process. Stay-course action maintains the same background processing speed.

The action signal notifies the dispatcher (e.g., BCP) to modify its dispatching policy behavior (e.g., number of threads, number of job requests per thread, increase or decrease rate, etc.). A dispatching policy may include, but is not limited to, the number of background async worker threads to be dispatched for processing in an async manner, the number of job requests per thread, the increase or decrease dispatching rate, the upper/lower limit of total job requests for all threads, etc. In some embodiments, the strategy for lean-in (e.g., the additional number of job requests to be dispatched through threads) may utilize certain techniques, such as linear series, Fibonacci increase, prime series increase, any customized methods, etc.

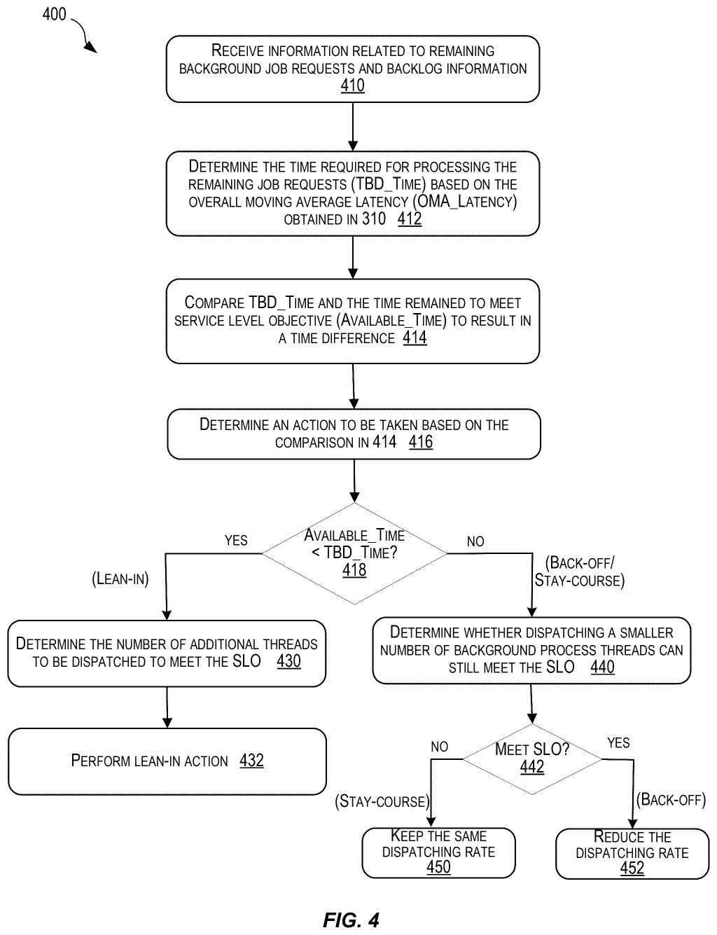

Additionally, the total number of job requests dispatched for execution should be within a threshold (e.g., upper limit/bound of 50 job requests and lower limit/bound of 30 job requests), according to the dispatching policy. Further details describing the above action decision are described below in FIG. 4 and the accompanying description.

In some embodiments, the feedback historical information (e.g., 126) rarely changes or changes much slower than the modification of dispatching policy (e.g., action decisions) and is typically affected by hardware changes in the remote system 116 (e.g., a cloud infrastructure service).

In certain embodiments, multiple background processes may be associated with a cloud infrastructure service. In other embodiments, many regulators of different background processes may share the same database (BKG DB).

As shown in FIG. 1, multiple background processes may run in parallel. In some embodiments, background processes may have different pre-defined priorities. Each regulator of a background process operates independently. However, when a regulator decides an action to take for its background process, it may consider the priority of other background processes. For example, suppose background process 110 has a higher priority than background process 130. If background process 110 needs to take a lean-in action while background process 130 is in stay-course condition, the background process 130 may decide to back-off to free up more resources for background process 110 to use. Both background processes 110 and 130 may communicate through the regulator communication network 180. In certain embodiments, a foreground process may signal a back-off request to background processes associated with the same cloud infrastructure service through the regulator communication network 180.

In some embodiments, the regulator communication network 180 may be a shared state of different regulators communicating via a common controller/agent. Each regulator (e.g., 112 and 132) may subscribe to the common agent for sharing its current state. The current information can be made available to a subscribing regulator by the common agent when that subscribing regulator is obtaining job requests, backlog and historical to help determine an action.

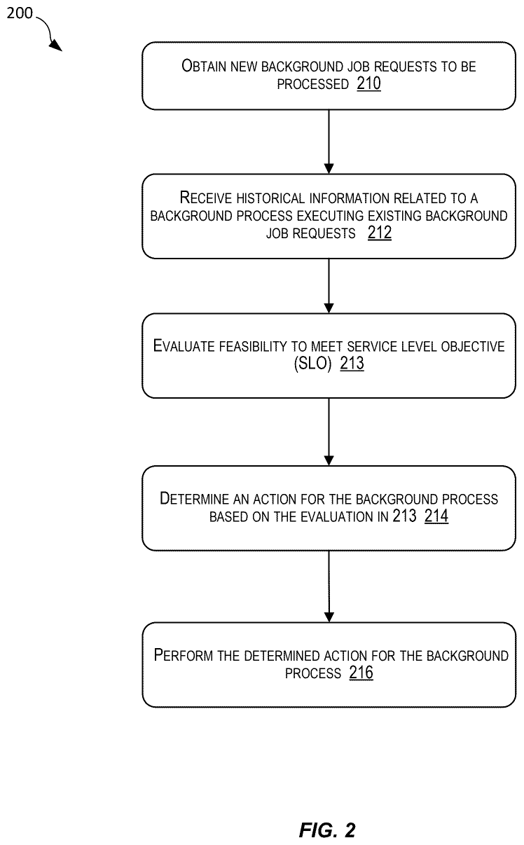

FIG. 2 is a flowchart illustrating a generalized method for an SLO-based regulator, according to some embodiments. The processing depicted in FIG. 2 may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIG. 2 and described below is intended to be illustrative and non-limiting. Although FIG. 2 depicts the various processing steps occurring in a particular sequence or order, this is not intended to be limiting. In certain alternative embodiments, the processing may be performed in some different order or some steps may also be performed in parallel. It should be appreciated that in alternative embodiments the processing depicted in FIG. 2 may include a greater number or a lesser number of steps than those depicted in FIG. 2.

At step 210, new background job requests to be processed may be obtained. For example, in FIG. 1, a regulator 112 of background process 110 may obtain new background job requests from database 111. In some embodiments, the regulator may fetch a batch of job requests (e.g., 30 to 50) to be dispatched by the background process based on a policy threshold. For example, a policy threshold may have a maximum of 50 requests and a minimum of 30 requests. In some embodiments, remaining background job requests and backlog information (e.g., Available_Time) may also be obtained from the database to help the regulator determine how far behind the background process is from the SLO.

At step 212, historical information related to a background processes executing existing background job requests may be received. For example, in FIG. 1, feedback information 126, including latency distribution information such as average latencies for the running threads may be received by the regulator 112 to calculate TBD_Tme by multiplying “remaining background job requests” and “moving average latency for executing a job request.” (to be discussed below).

At step 213, the feasibility of meeting the service level objective (SLO) is evaluated. For example, the regulator 112 may collect all received information (120 and 126, e.g., remaining background job requests, backlog information, and historical information) to evaluate whether the current dispatching pace can meet the SLO. For example, the evaluation may involve calculating an overall moving average latency (OMA_Latency) and the trend of the latency distribution.

At step 214, an action for the background process may be determined based on the evaluation in 213. For example, in FIG. 1, regulator 112 can compare TBD_Time (calculated based on OMA_latency) and Available_Time to determine whether the current pace of the background process can meet the SLO. The difference (referred to as DIFF_Time) between Available_Time and TBD_Time allows the regulator to figure out the additional number of background threads to dispatch if lean-in action is determined (i.e., TBD_Time is larger than the Available_Time), and the reduced number of background threads to dispatch if back-off action is determined (i.e., TBD_Time is smaller than the Available_Time). The regulator may dispatch the same number of background threads if DIFF_Time (=Available_Time-TBD_Time) is positive and within a pre-defined threshold (e.g., reducing one more thread may not meet SLO).

In certain embodiments, in addition to the DIFF_Time, the regulator may also take into account the latency trend (to be described later) of the background process, any back-off requests from a foreground process, or priorities of other background processes (as discussed earlier in relation to FIG. 1) to determine the action.

At step 216, the determined action for the background process may be performed. For example, in FIG. 1, regulator 112 may notify BCP 114 about the action to take (e.g., lean-in, back-off, or stay course). The BCP may increase, decrease, and maintain the dispatching rate accordingly while keeping the total number of dispatched job requests within the policy threshold.

FIG. 3 is a flowchart illustrating a method of evaluating latency distribution for a SLO-based regulator, according to some embodiments. The processing depicted in FIG. 3 may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIG. 3 and described below is intended to be illustrative and non-limiting. Although FIG. 3 depicts the various processing steps occurring in a particular sequence or order, this is not intended to be limiting. In certain alternative embodiments, the processing may be performed in some different order or some steps may also be performed in parallel. It should be appreciated that in alternative embodiments the processing depicted in FIG. 3 may include a greater number or a lesser number of steps than those depicted in FIG. 3.

As discussed earlier in relation to FIG. 1, a regulator (e.g., 112) may receive feedback information (e.g., 126), including historical information (e.g., average latency) for each of the dispatched background threads executing the background job requests.

At step 310, an overall moving average latency (OMA_Latency) of all dispatched background threads may be calculated based on a sliding window of past overall average latencies. OMA_Latency refers to the latency (or time) for a given thread to execute a job request, and can help the regulator to figure out its TBD_Time and, thus the action to take for the background process. In some embodiments, the OMA_Latency is calculated based on the past ten dispatches by the BCP (or ten fetches by the regulator)—i.e., a sliding window of ten.

For example, suppose a BCP (e.g., 114) of the background process initially dispatched 3 threads, and the average latencies from threads 1, 2, and 3 are 200 ms, 300 ms, and 260 ms, respectively. Each thread may dispatch a fixed number of job requests. Thus, the overall average latency is 253.33 ms (i.e., (200+300+260)/3) for the first set (or set #1) of dispatched threads. Similar calculations can be performed for the other nine sets of dispatched threads. At the eleventh fetch of job requests from BKG DB (e.g., 111) by the regulator (e.g., 112), which will result in the eleventh set dispatched threads (or set #11) by the BCP, the overall moving average latency, OMA_Latency, (i.e., the sum of the last ten overall average latencies (for set #1 to set #10)/10) may be obtained. Similarly, at the twelfth fetch by the regulator (set #12), the moving average latency (i.e., the sum of the last ten overall average latencies (set #2 to set #11)/10) can be obtained.

In some embodiments, if the number of fetches by the regulator or dispatches by the BCP is smaller than ten, the OMA_Latency may be calculated using the available overall average latencies. For example, during the sixth fetch by the regulator, the OMA_Latency may be calculated using the past five overall average latencies.

At step 320, a latency range category for each overall moving average latency (OMA_Latency) may be determined. In some embodiments, the value of OMA_Latency may be divided into three categories, such as high, medium, and low, where each category may be assigned a color and correspond to a configurable range of latency. For example, a low category (e.g., assigned a green color) may cover OMA_Latency below 150 ms. A medium category (e.g., assigned a yellow color) may cover OMA_Latency between 150 ms to 250 ms. A high category (e.g., assigned a red color) may cover OMA_Latency above 250 ms.

At step 330, a latency trend may be determined after every few numbers (i.e., a configurable number) of job request fetches. A latency trend may indicate the trend of changes in the OMA_Latency (i.e., overall moving average execution time), such as increasing or decreasing to help the regulator (e.g., 112) be aware of or anticipate the potential change in performance of the dispatched threads (or the health of the remote system 116). In some embodiments, the regulator may check the trend of OMA_Latency after every 5 to 10 fetches by looking at the percentage of different colors (or categories). For example, in the past 9 fetches, there were 5 reds (50%), 2 yellows (20%) and 2 greens (20%). Since red (i.e., high latency category) has a higher % than other colors, the regulator may determine the OMA_Latency has an increasing trend. If all three colors have roughly the same percentages (e.g., 30% for each), the regulator may determine the OMA_Latency has a stable trend. The more often (e.g., after every 5 fetches) the regulator checks the latency trend, the more responsive it is.

FIG. 4 is a flowchart illustrating a method of determining an action by an SLO-based regulator, according to some embodiments. The processing depicted in FIG. 4 may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIG. 4 and described below is intended to be illustrative and non-limiting. Although FIG. 4 depicts the various processing steps occurring in a particular sequence or order, this is not intended to be limiting. In certain alternative embodiments, the processing may be performed in some different order or some steps may also be performed in parallel. It should be appreciated that in alternative embodiments the processing depicted in FIG. 4 may include a greater number or a lesser number of steps than those depicted in FIG. 4.

As discussed above, an action determined by an SLO-based regulator can effect gradual changes (or avoid big changes) to the processing speed of background process, such that the expected execution time (i.e., TBD_Time) for processing the remaining job requests can meet the SLO (i.e., smaller than and close to Available_Time) while using the minimum amount of resources for the background process. The minimum amount of resources may be the smallest number of dispatching threads taken from the shared thread pool.

At step 410, information related to remaining background job requests and backlog information is received. As discussed earlier, the regulator (e.g., 112) may receive information from BKG DB about remaining background job requests and remaining epoch time. The regulator can use the remaining background job requests to figure out the TBD_Time (i.e., how much time is needed to complete the remaining job requests) and use the remaining epoch time to figure out the Available_Time (i.e., how much time is left to meet SLO). For example, suppose there is a total of 1.5 million background job requests in the BKG DB at the beginning of the epoch time (e.g., T0). Assume at time T1, such as 1 hour, the regulator fetches the eleventh batch of job requests, and the BKG DB indicates that there are 1.2 million remaining background job requests to be processed, and the Available_Time is 23 hours (i.e., 24 hours based on SLO subtracts 1 hour elapsed time).

At step 412, the time required for processing the remaining job requests (TBD_Time) is determined based on the overall moving average latency (OMA_Latency) obtained in 310. As discussed in relation to FIG. 3, OMA_Latency can be calculated and obtained based on feedback information (e.g., 126). Continuing with the above example, assuming the OMA_Latency is 231.483 ms at T1 and three background threads are executing the background job requests, the regulator can figure out the TBD_Time by multiplying the remaining background job requests (1.2 million) and OMA_Latency. As a result, the TBD_Time is 25.72 hours by performing the following calculation:

$$( ( 1 , 200 , 000 / 3 ) * 23 \; 1.4 \; 83 ) / ( 3600000 ) = 25.72 hours$$

At step 414, the time for completing the remaining job requests (i.e., TBD_Time) and the time remaining to meet SLO (i.e., Available_Time) are compared to determine the difference. Continuing with the above example, the time difference (DIFF_Time) between Available_Time and TBD_Time is-2.72 hours (i.e., 23-25.72 hours), indicating that the background process is behind the SLO for more than 2 hours.

At step 416, an action to be taken is determined based on the comparison or time difference (DIFF_Time) in 414. At step 418, if the background process is behind the SLO (i.e., Available_Time<TBD_Time, or negative DIFF_Time), a lean-in action may be taken, and the process proceeds to step 430. If the background process is ahead of the SLO (i.e., Available_Time>TBD_Time, or positive DIFF_Time), the process proceeds to step 440.

At step 430, the number of additional threads to be dispatched to meet the SLO may be determined. As discussed above, when the background process (e.g., 110) is behind the SLO, the regulator (e.g., 112) may signal the BCP (e.g., 114) to increase the number of dispatching threads. Continuing with the above example, the regulator may estimate the potential TBD_Time for using four threads (i.e., add one additional thread to the existing three threads) under the OMA_Latency (231.483 ms) to complete the remaining background job requests (1.2 million), by performing the following calculation:

$$( ( 1 , 200000 / 4 ) * 23 \; 1.4 \; 83 ) / ( 3600000 ) = 19.29 hours$$

The resulting TBD_Time is 19.29 hours, which is smaller than the Available_Time (23 hours). Thus, dispatching one additional thread should be able to help the background process speed up and meet SLO. There is no need to have more than four threads to conserve resources, and one additional thread will not cause a big swing in processing speed. However, the total number of job requests to be executed by four threads should still be within the dispatching policy's upper limit (e.g., 50 job requests).

In some embodiments, the regulator currently performing a lean-in action may send out (or broadcast) a back-off signal through the regulator communication network 180 to other background processes with lower priorities, such that other low-priority processes may back-off to yield more resources for high-priority processes.

At step 432, the lean-in action is performed. In other words, the BCP dispatches four threads to execute the fetched job requests by the regulator.

At step 440, whether dispatching a smaller number of background process threads can still meet the SLO is determined. At step 442, if the answer is No, the process proceeds to step 450, in which a stay-course action is taken, and the same dispatching rate is kept. If the answer is Yes, the process proceeds to step 452, in which a back-off action is taken.

For example, assuming at time T1, the BKG DB indicates that there are 1 million remaining background job requests to be processed, and the Available_Time is 23 hours. Thus, the estimates of TBD_Time for three threads (i.e., current number of dispatched threads) and two threads (i.e., reduced number of threads) can be obtained by performing the following calculation:

$$For three threads , ( ( 1 , 000 , 000 / 3 ) * 23 \; 1.4 \; 83 ) / ( 3600000 ) = 21.43 hours \\ For two threads , ( ( 1 , 000 , 000 / 2 ) * 23 \; 1.4 \; 83 ) / ( 3600000 ) = 32.15 hours$$

Since the estimated TBD_Time (21.43 hours) for three threads is slightly below the Available_Time (23 hours) but the estimated TBD_Time (32.15 hours) for two threads will exceed the Available_Time (i.e., not meeting SLO), the regulator will signal a stay-course action to BCP to keep current the dispatching rate.

However, assuming the BKG DB indicates that there are 0.3 million remaining background job requests to be processed, the Available_Time is 23 hours. Thus, the estimates of TBD_Time for three threads (i.e., current number of dispatched threads), two threads, and one thread (i.e., reduced number of threads) can be obtained by performing the following calculation:

$$For three threads , ( ( 300 , 000 / 3 ) * 231.483 ) / ( 3600000 ) = 6.43 hours \\ For two threads , ( ( 300 , 000 / 2 ) * 23 \; 1.4 \; 83 ) / ( 3600000 ) = 9.65 hours \\ For one threads , ( ( 300 , 000 ) * 231.483 ) / ( 3600000 ) = 19.29 hours$$

Since the estimated TBD_Time for a smaller number of threads can still meet the SLO (i.e., below the Available_Time (23 hours)), such as 9.65 hours for two threads and 19.29 hours for one thread, the regulator will signal a back-off action.

At step 452, the dispatching rate may be reduced. The number of reduced threads may be selected depending on several factors, such as latency trend and back-off signals from other processes. For example, by default, the BCP may reduce its dispatching rate to the smallest number of threads (e.g., one thread in this example) to conserve resources. However, the total number of job requests to be executed by one thread should still be within the policy lower limit (e.g., 30 job requests).

In certain embodiments, the number of threads to be reduced for a back-off action may take into account the latency trend. For example, if the latency trend indicates a trend of increasing latency, the regulator may decide to reduce to dispatching two threads instead of dispatching only one thread since an increasing latency trend implies the executing threads may slow down in the near future due to potential health issue (e.g., overload) in the remote system (e.g., cloud infrastructure service).

As discussed earlier, in some embodiments, if the regulator receives back-off signals from either a foreground process or another background process with higher priority through regulator communication network 180, the regulator may request BCP to reduce its dispatching rate to the smallest allowed number of thread, for example, one thread, in this example, that still meet the policy's lower limit.

### Example Cloud Service Provider Infrastructure (CSPI) Architectures

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

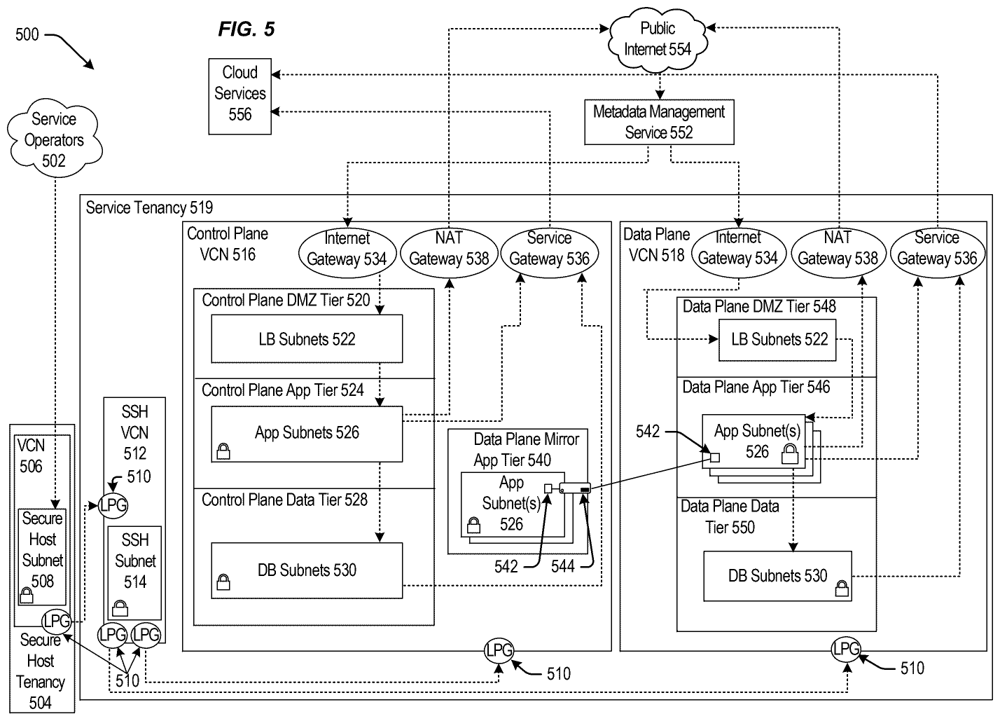

FIG. 5 is a block diagram 500 illustrating an example pattern of an IaaS architecture, according to at least one embodiment. Service operators 502 can be communicatively coupled to a secure host tenancy 504 that can include a virtual cloud network (VCN) 506 and a secure host subnet 508. In some examples, the service operators 502 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 506 and/or the Internet.

The VCN 506 can include a local peering gateway (LPG) 510 that can be communicatively coupled to a secure shell (SSH) VCN 512 via an LPG 510 contained in the SSH VCN 512. The SSH VCN 512 can include an SSH subnet 514, and the SSH VCN 512 can be communicatively coupled to a control plane VCN 516 via the LPG 510 contained in the control plane VCN 516. Also, the SSH VCN 512 can be communicatively coupled to a data plane VCN 518 via an LPG 510. The control plane VCN 516 and the data plane VCN 518 can be contained in a service tenancy 519 that can be owned and/or operated by the IaaS provider.

The control plane VCN 516 can include a control plane demilitarized zone (DMZ) tier 520 that acts as a perimeter network (e.g., portions of a corporate network between the corporate intranet and external networks). The DMZ-based servers may have restricted responsibilities and help keep breaches contained. Additionally, the DMZ tier 520 can include one or more load balancer (LB) subnet(s) 522, a control plane app tier 524 that can include app subnet(s) 526, a control plane data tier 528 that can include database (DB) subnet(s) 530 (e.g., frontend DB subnet(s) and/or backend DB subnet(s)). The LB subnet(s) 522 contained in the control plane DMZ tier 520 can be communicatively coupled to the app subnet(s) 526 contained in the control plane app tier 524 and an Internet gateway 534 that can be contained in the control plane VCN 516, and the app subnet(s) 526 can be communicatively coupled to the DB subnet(s) 530 contained in the control plane data tier 528 and a service gateway 536 and a network address translation (NAT) gateway 538. The control plane VCN 516 can include the service gateway 536 and the NAT gateway 538.

The control plane VCN 516 can include a data plane mirror app tier 540 that can include app subnet(s) 526. The app subnet(s) 526 contained in the data plane mirror app tier 540 can include a virtual network interface controller (VNIC) 542 that can execute a compute instance 544. The compute instance 544 can communicatively couple the app subnet(s) 526 of the data plane mirror app tier 540 to app subnet(s) 526 that can be contained in a data plane app tier 546.

The data plane VCN 518 can include the data plane app tier 546, a data plane DMZ tier 548, and a data plane data tier 550. The data plane DMZ tier 548 can include LB subnet(s) 522 that can be communicatively coupled to the app subnet(s) 526 of the data plane app tier 546 and the Internet gateway 534 of the data plane VCN 518. The app subnet(s) 526 can be communicatively coupled to the service gateway 536 of the data plane VCN 518 and the NAT gateway 538 of the data plane VCN 518. The data plane data tier 550 can also include the DB subnet(s) 530 that can be communicatively coupled to the app subnet(s) 526 of the data plane app tier 546.

The Internet gateway 534 of the control plane VCN 516 and of the data plane VCN 518 can be communicatively coupled to a metadata management service 552 that can be communicatively coupled to public Internet 554. Public Internet 554 can be communicatively coupled to the NAT gateway 538 of the control plane VCN 516 and of the data plane VCN 518. The service gateway 536 of the control plane VCN 516 and of the data plane VCN 518 can be communicatively coupled to cloud services 556.

In some examples, the service gateway 536 of the control plane VCN 516 or of the data plane VCN 518 can make application programming interface (API) calls to cloud services 556 without going through public Internet 554. The API calls to cloud services 556 from the service gateway 536 can be one-way: the service gateway 536 can make API calls to cloud services 556, and cloud services 556 can send requested data to the service gateway 536. But, cloud services 556 may not initiate API calls to the service gateway 536.

In some examples, the secure host tenancy 504 can be directly connected to the service tenancy 519, which may be otherwise isolated. The secure host subnet 508 can communicate with the SSH subnet 514 through an LPG 510 that may enable two-way communication over an otherwise isolated system. Connecting the secure host subnet 508 to the SSH subnet 514 may give the secure host subnet 508 access to other entities within the service tenancy 519.

The control plane VCN 516 may allow users of the service tenancy 519 to set up or otherwise provision desired resources. Desired resources provisioned in the control plane VCN 516 may be deployed or otherwise used in the data plane VCN 518. In some examples, the control plane VCN 516 can be isolated from the data plane VCN 518, and the data plane mirror app tier 540 of the control plane VCN 516 can communicate with the data plane app tier 546 of the data plane VCN 518 via VNICs 542 that can be contained in the data plane mirror app tier 540 and the data plane app tier 546.

In some examples, users of the system, or customers, can make requests, for example create, read, update, or delete (CRUD) operations, through public Internet 554 that can communicate the requests to the metadata management service 552. The metadata management service 552 can communicate the request to the control plane VCN 516 through the Internet gateway 534. The request can be received by the LB subnet(s) 522 contained in the control plane DMZ tier 520. The LB subnet(s) 522 may determine that the request is valid, and in response to this determination, the LB subnet(s) 522 can transmit the request to app subnet(s) 526 contained in the control plane app tier 524. If the request is validated and requires a call to public Internet 554, the call to public Internet 554 may be transmitted to the NAT gateway 538 that can make the call to public Internet 554. Metadata that may be desired to be stored by the request can be stored in the DB subnet(s) 530.

In some examples, the data plane mirror app tier 540 can facilitate direct communication between the control plane VCN 516 and the data plane VCN 518. For example, changes, updates, or other suitable modifications to configuration may be desired to be applied to the resources contained in the data plane VCN 518. Via a VNIC 542, the control plane VCN 516 can directly communicate with, and can thereby execute the changes, updates, or other suitable modifications to configuration to, resources contained in the data plane VCN 518.

In some embodiments, the control plane VCN 516 and the data plane VCN 518 can be contained in the service tenancy 519. In this case, the user, or the customer, of the system may not own or operate either the control plane VCN 516 or the data plane VCN 518. Instead, the IaaS provider may own or operate the control plane VCN 516 and the data plane VCN 518, both of which may be contained in the service tenancy 519. This embodiment can enable isolation of networks that may prevent users or customers from interacting with other users', or other customers', resources. Also, this embodiment may allow users or customers of the system to store databases privately without needing to rely on public Internet 554, which may not have a desired level of threat prevention, for storage.

In other embodiments, the LB subnet(s) 522 contained in the control plane VCN 516 can be configured to receive a signal from the service gateway 536. In this embodiment, the control plane VCN 516 and the data plane VCN 518 may be configured to be called by a customer of the IaaS provider without calling public Internet 554. Customers of the IaaS provider may desire this embodiment since database(s) that the customers use may be controlled by the IaaS provider and may be stored on the service tenancy 519, which may be isolated from public Internet 554.

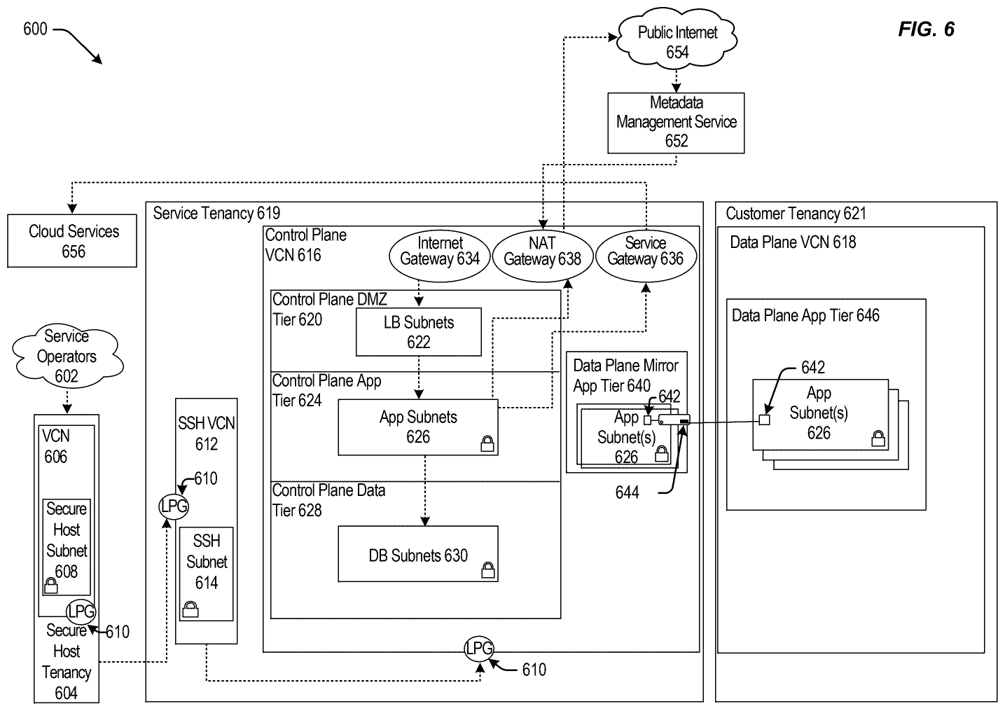

FIG. 6 is a block diagram 600 illustrating another example pattern of an IaaS architecture, according to at least one embodiment. Service operators 602 (e.g., service operators 502 of FIG. 5) can be communicatively coupled to a secure host tenancy 604 (e.g., the secure host tenancy 504 of FIG. 5) that can include a virtual cloud network (VCN) 606 (e.g., the VCN 506 of FIG. 5) and a secure host subnet 608 (e.g., the secure host subnet 508 of FIG. 5). The VCN 606 can include a local peering gateway (LPG) 610 (e.g., the LPG 510 of FIG. 5) that can be communicatively coupled to a secure shell (SSH) VCN 612 (e.g., the SSH VCN 512 of FIG. 5) via an LPG 510 contained in the SSH VCN 612. The SSH VCN 612 can include an SSH subnet 614 (e.g., the SSH subnet 514 of FIG. 5), and the SSH VCN 612 can be communicatively coupled to a control plane VCN 616 (e.g., the control plane VCN 516 of FIG. 5) via an LPG 610 contained in the control plane VCN 616. The control plane VCN 616 can be contained in a service tenancy 619 (e.g., the service tenancy 519 of FIG. 5), and the data plane VCN 618 (e.g., the data plane VCN 518 of FIG. 5) can be contained in a customer tenancy 621 that may be owned or operated by users, or customers, of the system.

The control plane VCN 616 can include a control plane DMZ tier 620 (e.g., the control plane DMZ tier 520 of FIG. 5) that can include LB subnet(s) 622 (e.g., LB subnet(s) 522 of FIG. 5), a control plane app tier 624 (e.g., the control plane app tier 524 of FIG. 5) that can include app subnet(s) 626 (e.g., app subnet(s) 526 of FIG. 5), a control plane data tier 628 (e.g., the control plane data tier 528 of FIG. 5) that can include database (DB) subnet(s) 630 (e.g., similar to DB subnet(s) 530 of FIG. 5). The LB subnet(s) 622 contained in the control plane DMZ tier 620 can be communicatively coupled to the app subnet(s) 626 contained in the control plane app tier 624 and an Internet gateway 634 (e.g., the Internet gateway 534 of FIG. 5) that can be contained in the control plane VCN 616, and the app subnet(s) 626 can be communicatively coupled to the DB subnet(s) 630 contained in the control plane data tier 628 and a service gateway 636 (e.g., the service gateway 536 of FIG. 5) and a network address translation (NAT) gateway 638 (e.g., the NAT gateway 538 of FIG. 5). The control plane VCN 616 can include the service gateway 636 and the NAT gateway 638.

The control plane VCN 616 can include a data plane mirror app tier 640 (e.g., the data plane mirror app tier 540 of FIG. 5) that can include app subnet(s) 626. The app subnet(s) 626 contained in the data plane mirror app tier 640 can include a virtual network interface controller (VNIC) 642 (e.g., the VNIC of 542) that can execute a compute instance 644 (e.g., similar to the compute instance 544 of FIG. 5). The compute instance 644 can facilitate communication between the app subnet(s) 626 of the data plane mirror app tier 640 and the app subnet(s) 626 that can be contained in a data plane app tier 646 (e.g., the data plane app tier 546 of FIG. 5) via the VNIC 642 contained in the data plane mirror app tier 640 and the VNIC 642 contained in the data plane app tier 646.

The Internet gateway 634 contained in the control plane VCN 616 can be communicatively coupled to a metadata management service 652 (e.g., the metadata management service 552 of FIG. 5) that can be communicatively coupled to public Internet 654 (e.g., public Internet 554 of FIG. 5). Public Internet 654 can be communicatively coupled to the NAT gateway 638 contained in the control plane VCN 616. The service gateway 636 contained in the control plane VCN 616 can be communicatively coupled to cloud services 656 (e.g., cloud services 556 of FIG. 5).

In some examples, the data plane VCN 618 can be contained in the customer tenancy 621. In this case, the IaaS provider may provide the control plane VCN 616 for each customer, and the IaaS provider may, for each customer, set up a unique compute instance 644 that is contained in the service tenancy 619. Each compute instance 644 may allow communication between the control plane VCN 616, contained in the service tenancy 619, and the data plane VCN 618 that is contained in the customer tenancy 621. The compute instance 644 may allow resources, that are provisioned in the control plane VCN 616 that is contained in the service tenancy 619, to be deployed or otherwise used in the data plane VCN 618 that is contained in the customer tenancy 621.

In other examples, the customer of the IaaS provider may have databases that live in the customer tenancy 621. In this example, the control plane VCN 616 can include the data plane mirror app tier 640 that can include app subnet(s) 626. The data plane mirror app tier 640 can reside in the data plane VCN 618, but the data plane mirror app tier 640 may not live in the data plane VCN 618. That is, the data plane mirror app tier 640 may have access to the customer tenancy 621, but the data plane mirror app tier 640 may not exist in the data plane VCN 618 or be owned or operated by the customer of the IaaS provider. The data plane mirror app tier 640 may be configured to make calls to the data plane VCN 618 but may not be configured to make calls to any entity contained in the control plane VCN 616. The customer may desire to deploy or otherwise use resources in the data plane VCN 618 that are provisioned in the control plane VCN 616, and the data plane mirror app tier 640 can facilitate the desired deployment, or other usage of resources, of the customer.

In some embodiments, the customer of the IaaS provider can apply filters to the data plane VCN 618. In this embodiment, the customer can determine what the data plane VCN 618 can access, and the customer may restrict access to public Internet 654 from the data plane VCN 618. The IaaS provider may not be able to apply filters or otherwise control access of the data plane VCN 618 to any outside networks or databases. Applying filters and controls by the customer onto the data plane VCN 618, contained in the customer tenancy 621, can help isolate the data plane VCN 618 from other customers and from public Internet 654.

In some embodiments, cloud services 656 can be called by the service gateway 636 to access services that may not exist on public Internet 654, on the control plane VCN 616, or on the data plane VCN 618. The connection between cloud services 656 and the control plane VCN 616 or the data plane VCN 618 may not be live or continuous. Cloud services 656 may exist on a different network owned or operated by the IaaS provider. Cloud services 656 may be configured to receive calls from the service gateway 636 and may be configured to not receive calls from public Internet 654. Some cloud services 656 may be isolated from other cloud services 656, and the control plane VCN 616 may be isolated from cloud services 656 that may not be in the same region as the control plane VCN 616. For example, the control plane VCN 616 may be located in “Region 1,” and cloud service “Deployment 5,” may be located in Region 1 and in “Region 2.” If a call to Deployment 5 is made by the service gateway 636 contained in the control plane VCN 616 located in Region 1, the call may be transmitted to Deployment 5 in Region 1. In this example, the control plane VCN 616, or Deployment 5 in Region 1, may not be communicatively coupled to, or otherwise in communication with, Deployment 5 in Region 2.

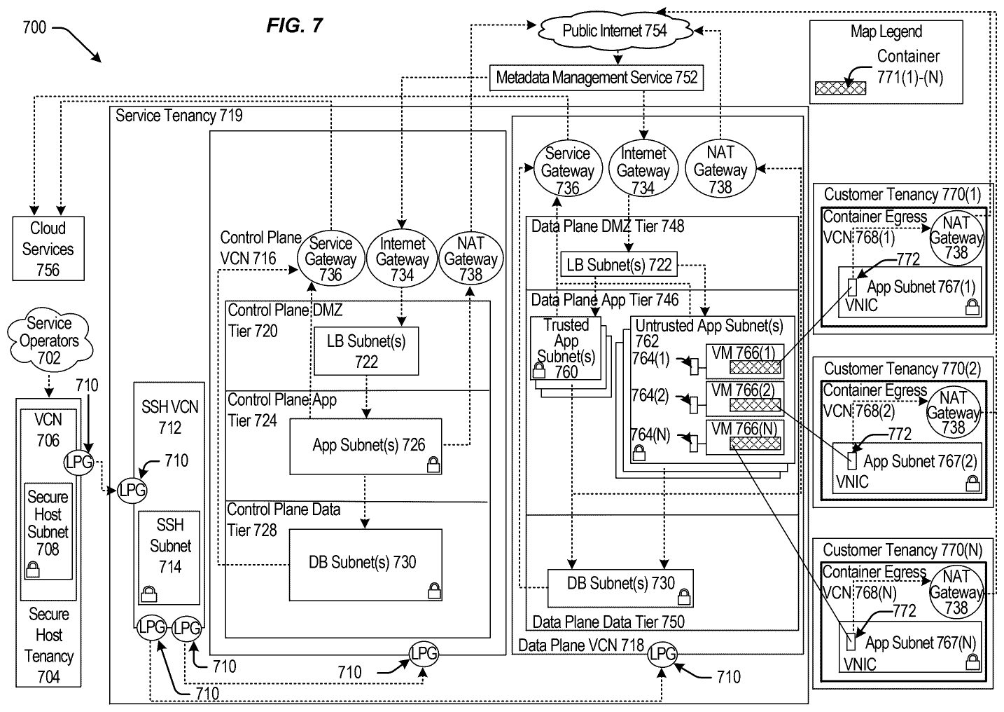

FIG. 7 is a block diagram 700 illustrating another example pattern of an IaaS architecture, according to at least one embodiment. Service operators 702 (e.g., service operators 502 of FIG. 5) can be communicatively coupled to a secure host tenancy 704 (e.g., the secure host tenancy 504 of FIG. 5) that can include a virtual cloud network (VCN) 706 (e.g., the VCN 506 of FIG. 5) and a secure host subnet 708 (e.g., the secure host subnet 508 of FIG. 5). The VCN 706 can include an LPG 710 (e.g., the LPG 510 of FIG. 5) that can be communicatively coupled to an SSH VCN 712 (e.g., the SSH VCN 512 of FIG. 5) via an LPG 710 contained in the SSH VCN 712. The SSH VCN 712 can include an SSH subnet 714 (e.g., the SSH subnet 514 of FIG. 5), and the SSH VCN 712 can be communicatively coupled to a control plane VCN 716 (e.g., the control plane VCN 516 of FIG. 5) via an LPG 710 contained in the control plane VCN 716 and to a data plane VCN 718 (e.g., the data plane 518 of FIG. 5) via an LPG 710 contained in the data plane VCN 718. The control plane VCN 716 and the data plane VCN 718 can be contained in a service tenancy 719 (e.g., the service tenancy 519 of FIG. 5).

The control plane VCN 716 can include a control plane DMZ tier 720 (e.g., the control plane DMZ tier 520 of FIG. 5) that can include load balancer (LB) subnet(s) 722 (e.g., LB subnet(s) 522 of FIG. 5), a control plane app tier 724 (e.g., the control plane app tier 524 of FIG. 5) that can include app subnet(s) 726 (e.g., similar to app subnet(s) 526 of FIG. 5), a control plane data tier 728 (e.g., the control plane data tier 528 of FIG. 5) that can include DB subnet(s) 730. The LB subnet(s) 722 contained in the control plane DMZ tier 720 can be communicatively coupled to the app subnet(s) 726 contained in the control plane app tier 724 and to an Internet gateway 734 (e.g., the Internet gateway 534 of FIG. 5) that can be contained in the control plane VCN 716, and the app subnet(s) 726 can be communicatively coupled to the DB subnet(s) 730 contained in the control plane data tier 728 and to a service gateway 736 (e.g., the service gateway of FIG. 5) and a network address translation (NAT) gateway 738 (e.g., the NAT gateway 538 of FIG. 5). The control plane VCN 716 can include the service gateway 736 and the NAT gateway 738.

The data plane VCN 718 can include a data plane app tier 746 (e.g., the data plane app tier 546 of FIG. 5), a data plane DMZ tier 748 (e.g., the data plane DMZ tier 548 of FIG. 5), and a data plane data tier 750 (e.g., the data plane data tier 550 of FIG. 5). The data plane DMZ tier 748 can include LB subnet(s) 722 that can be communicatively coupled to trusted app subnet(s) 760 and untrusted app subnet(s) 762 of the data plane app tier 746 and the Internet gateway 734 contained in the data plane VCN 718. The trusted app subnet(s) 760 can be communicatively coupled to the service gateway 736 contained in the data plane VCN 718, the NAT gateway 738 contained in the data plane VCN 718, and DB subnet(s) 730 contained in the data plane data tier 750. The untrusted app subnet(s) 762 can be communicatively coupled to the service gateway 736 contained in the data plane VCN 718 and DB subnet(s) 730 contained in the data plane data tier 750. The data plane data tier 750 can include DB subnet(s) 730 that can be communicatively coupled to the service gateway 736 contained in the data plane VCN 718.

The untrusted app subnet(s) 762 can include one or more primary VNICs 764(1)-(N) that can be communicatively coupled to tenant virtual machines (VMs) 766(1)-(N). Each tenant VM 766(1)-(N) can be communicatively coupled to a respective app subnet 767(1)-(N) that can be contained in respective container egress VCNs 768(1)-(N) that can be contained in respective customer tenancies 770(1)-(N). Respective secondary VNICs 772(1)-(N) can facilitate communication between the untrusted app subnet(s) 762 contained in the data plane VCN 718 and the app subnet contained in the container egress VCNs 768(1)-(N). Each container egress VCNs 768(1)-(N) can include a NAT gateway 738 that can be communicatively coupled to public Internet 754 (e.g., public Internet 554 of FIG. 5).

The Internet gateway 734 contained in the control plane VCN 716 and contained in the data plane VCN 718 can be communicatively coupled to a metadata management service 752 (e.g., the metadata management system 552 of FIG. 5) that can be communicatively coupled to public Internet 754. Public Internet 754 can be communicatively coupled to the NAT gateway 738 contained in the control plane VCN 716 and contained in the data plane VCN 718. The service gateway 736 contained in the control plane VCN 716 and contained in the data plane VCN 718 can be communicatively coupled to cloud services 756.

In some embodiments, the data plane VCN 718 can be integrated with customer tenancies 770. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 746. Code to run the function may be executed in the VMs 766(1)-(N), and the code may not be configured to run anywhere else on the data plane VCN 718. Each VM 766(1)-(N) may be connected to one customer tenancy 770. Respective containers 771(1)-(N) contained in the VMs 766(1)-(N) may be configured to run the code. In this case, there can be a dual isolation (e.g., the containers 771(1)-(N) running code, where the containers 771(1)-(N) may be contained in at least the VM 766(1)-(N) that are contained in the untrusted app subnet(s) 762), which may help prevent incorrect or otherwise undesirable code from damaging the network of the IaaS provider or from damaging a network of a different customer. The containers 771(1)-(N) may be communicatively coupled to the customer tenancy 770 and may be configured to transmit or receive data from the customer tenancy 770. The containers 771(1)-(N) may not be configured to transmit or receive data from any other entity in the data plane VCN 718. Upon completion of running the code, the IaaS provider may kill or otherwise dispose of the containers 771(1)-(N).

In some embodiments, the trusted app subnet(s) 760 may run code that may be owned or operated by the IaaS provider. In this embodiment, the trusted app subnet(s) 760 may be communicatively coupled to the DB subnet(s) 730 and be configured to execute CRUD operations in the DB subnet(s) 730. The untrusted app subnet(s) 762 may be communicatively coupled to the DB subnet(s) 730, but in this embodiment, the untrusted app subnet(s) may be configured to execute read operations in the DB subnet(s) 730. The containers 771(1)-(N) that can be contained in the VM 766(1)-(N) of each customer and that may run code from the customer may not be communicatively coupled with the DB subnet(s) 730.

In other embodiments, the control plane VCN 716 and the data plane VCN 718 may not be directly communicatively coupled. In this embodiment, there may be no direct communication between the control plane VCN 716 and the data plane VCN 718. However, communication can occur indirectly through at least one method. An LPG 710 may be established by the IaaS provider that can facilitate communication between the control plane VCN 716 and the data plane VCN 718. In another example, the control plane VCN 716 or the data plane VCN 718 can make a call to cloud services 756 via the service gateway 736. For example, a call to cloud services 756 from the control plane VCN 716 can include a request for a service that can communicate with the data plane VCN 718.

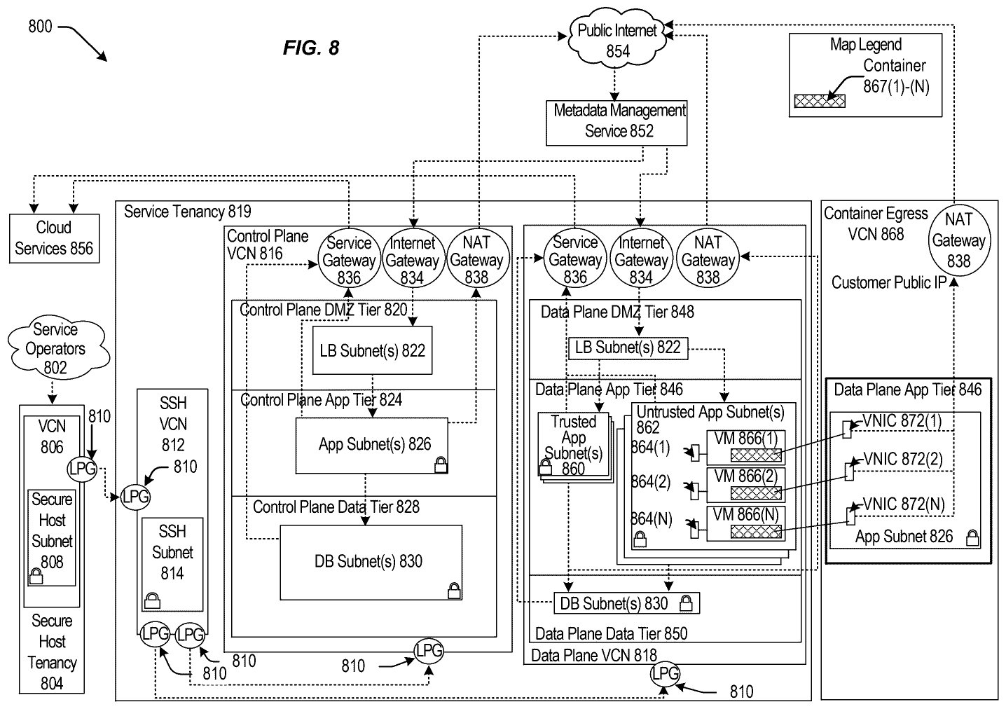

FIG. 8 is a block diagram 800 illustrating another example pattern of an IaaS architecture, according to at least one embodiment. Service operators 802 (e.g., service operators 502 of FIG. 5) can be communicatively coupled to a secure host tenancy 804 (e.g., the secure host tenancy 504 of FIG. 5) that can include a virtual cloud network (VCN) 806 (e.g., the VCN 506 of FIG. 5) and a secure host subnet 808 (e.g., the secure host subnet 508 of FIG. 5). The VCN 806 can include an LPG 810 (e.g., the LPG 510 of FIG. 5) that can be communicatively coupled to an SSH VCN 812 (e.g., the SSH VCN 512 of FIG. 5) via an LPG 810 contained in the SSH VCN 812. The SSH VCN 812 can include an SSH subnet 814 (e.g., the SSH subnet 514 of FIG. 5), and the SSH VCN 812 can be communicatively coupled to a control plane VCN 816 (e.g., the control plane VCN 516 of FIG. 5) via an LPG 810 contained in the control plane VCN 816 and to a data plane VCN 818 (e.g., the data plane 518 of FIG. 5) via an LPG 810 contained in the data plane VCN 818. The control plane VCN 816 and the data plane VCN 818 can be contained in a service tenancy 819 (e.g., the service tenancy 519 of FIG. 5).

The control plane VCN 816 can include a control plane DMZ tier 820 (e.g., the control plane DMZ tier 520 of FIG. 5) that can include LB subnet(s) 822 (e.g., LB subnet(s) 522 of FIG. 5), a control plane app tier 824 (e.g., the control plane app tier 524 of FIG. 5) that can include app subnet(s) 826 (e.g., app subnet(s) 526 of FIG. 5), a control plane data tier 828 (e.g., the control plane data tier 528 of FIG. 5) that can include DB subnet(s) 830 (e.g., DB subnet(s) 730 of FIG. 7). The LB subnet(s) 822 contained in the control plane DMZ tier 820 can be communicatively coupled to the app subnet(s) 826 contained in the control plane app tier 824 and to an Internet gateway 834 (e.g., the Internet gateway 534 of FIG. 5) that can be contained in the control plane VCN 816, and the app subnet(s) 826 can be communicatively coupled to the DB subnet(s) 830 contained in the control plane data tier 828 and to a service gateway 836 (e.g., the service gateway of FIG. 5) and a network address translation (NAT) gateway 838 (e.g., the NAT gateway 538 of FIG. 5). The control plane VCN 816 can include the service gateway 836 and the NAT gateway 838.

The data plane VCN 818 can include a data plane app tier 846 (e.g., the data plane app tier 546 of FIG. 5), a data plane DMZ tier 848 (e.g., the data plane DMZ tier 548 of FIG. 5), and a data plane data tier 850 (e.g., the data plane data tier 550 of FIG. 5). The data plane DMZ tier 848 can include LB subnet(s) 822 that can be communicatively coupled to trusted app subnet(s) 860 (e.g., trusted app subnet(s) 760 of FIG. 7) and untrusted app subnet(s) 862 (e.g., untrusted app subnet(s) 762 of FIG. 7) of the data plane app tier 846 and the Internet gateway 834 contained in the data plane VCN 818. The trusted app subnet(s) 860 can be communicatively coupled to the service gateway 836 contained in the data plane VCN 818, the NAT gateway 838 contained in the data plane VCN 818, and DB subnet(s) 830 contained in the data plane data tier 850. The untrusted app subnet(s) 862 can be communicatively coupled to the service gateway 836 contained in the data plane VCN 818 and DB subnet(s) 830 contained in the data plane data tier 850. The data plane data tier 850 can include DB subnet(s) 830 that can be communicatively coupled to the service gateway 836 contained in the data plane VCN 818.

The untrusted app subnet(s) 862 can include primary VNICs 864(1)-(N) that can be communicatively coupled to tenant virtual machines (VMs) 866(1)-(N) residing within the untrusted app subnet(s) 862. Each tenant VM 866(1)-(N) can run code in a respective container 867(1)-(N), and be communicatively coupled to an app subnet 826 that can be contained in a data plane app tier 846 that can be contained in a container egress VCN 868. Respective secondary VNICs 872(1)-(N) can facilitate communication between the untrusted app subnet(s) 862 contained in the data plane VCN 818 and the app subnet contained in the container egress VCN 868. The container egress VCN can include a NAT gateway 838 that can be communicatively coupled to public Internet 854 (e.g., public Internet 554 of FIG. 5).

The Internet gateway 834 contained in the control plane VCN 816 and contained in the data plane VCN 818 can be communicatively coupled to a metadata management service 852 (e.g., the metadata management system 552 of FIG. 5) that can be communicatively coupled to public Internet 854. Public Internet 854 can be communicatively coupled to the NAT gateway 838 contained in the control plane VCN 816 and contained in the data plane VCN 818. The service gateway 836 contained in the control plane VCN 816 and contained in the data plane VCN 818 can be communicatively coupled to cloud services 856.

In some examples, the pattern illustrated by the architecture of block diagram 800 of FIG. 8 may be considered an exception to the pattern illustrated by the architecture of block diagram 700 of FIG. 7 and may be desirable for a customer of the IaaS provider if the IaaS provider cannot directly communicate with the customer (e.g., a disconnected region). The respective containers 867(1)-(N) that are contained in the VMs 866(1)-(N) for each customer can be accessed in real-time by the customer. The containers 867(1)-(N) may be configured to make calls to respective secondary VNICs 872(1)-(N) contained in app subnet(s) 826 of the data plane app tier 846 that can be contained in the container egress VCN 868. The secondary VNICs 872(1)-(N) can transmit the calls to the NAT gateway 838 that may transmit the calls to public Internet 854. In this example, the containers 867(1)-(N) that can be accessed in real-time by the customer can be isolated from the control plane VCN 816 and can be isolated from other entities contained in the data plane VCN 818. The containers 867(1)-(N) may also be isolated from resources from other customers.

In other examples, the customer can use the containers 867(1)-(N) to call cloud services 856. In this example, the customer may run code in the containers 867(1)-(N) that requests a service from cloud services 856. The containers 867(1)-(N) can transmit this request to the secondary VNICs 872(1)-(N) that can transmit the request to the NAT gateway that can transmit the request to public Internet 854. Public Internet 854 can transmit the request to LB subnet(s) 822 contained in the control plane VCN 816 via the Internet gateway 834. In response to determining the request is valid, the LB subnet(s) can transmit the request to app subnet(s) 826 that can transmit the request to cloud services 856 via the service gateway 836.

It should be appreciated that IaaS architectures 500, 600, 700, 800 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

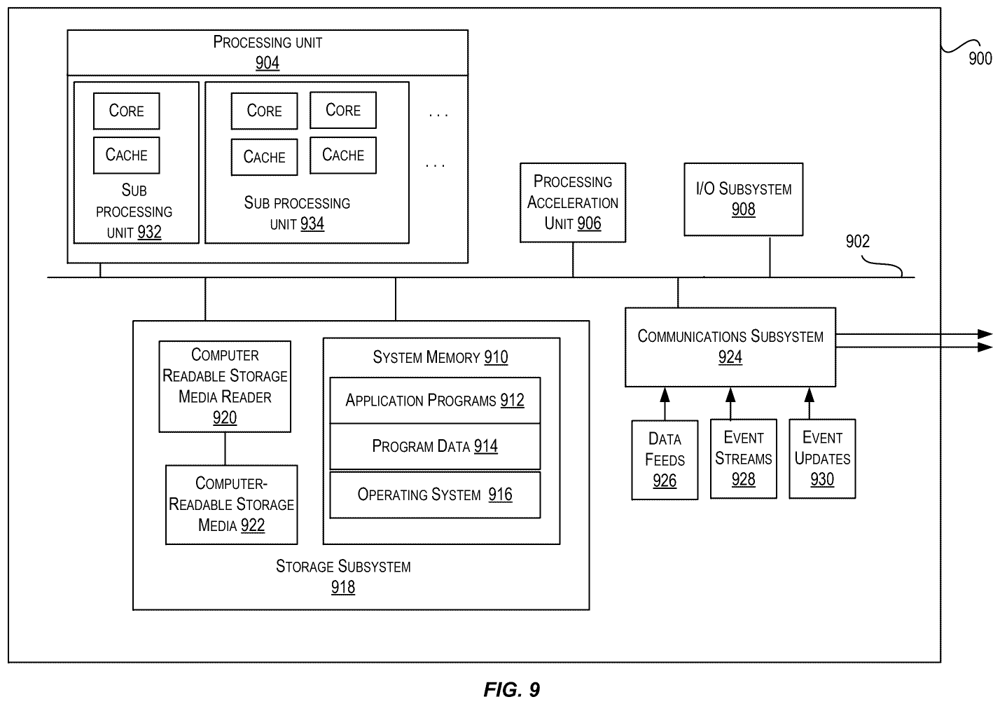

FIG. 9 illustrates an example computer system 900, in which various embodiments may be implemented. The system 900 may be used to implement any of the computer systems described above. As shown in the figure, computer system 900 includes a processing unit 904 that communicates with a number of peripheral subsystems via a bus subsystem 902. These peripheral subsystems may include a processing acceleration unit 906, an I/O subsystem 908, a storage subsystem 918 and a communications subsystem 924. Storage subsystem 918 includes tangible computer-readable storage media 922 and a system memory 910.

Bus subsystem 902 provides a mechanism for letting the various components and subsystems of computer system 900 communicate with each other as intended. Although bus subsystem 902 is shown schematically as a single bus, alternative embodiments of the bus subsystem may utilize multiple buses. Bus subsystem 902 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 904, which can be implemented as one or more integrated circuits (e.g., a conventional microprocessor or microcontroller), controls the operation of computer system 900. One or more processors may be included in processing unit 904. These processors may include single core or multicore processors. In certain embodiments, processing unit 904 may be implemented as one or more independent processing units 932 and/or 934 with single or multicore processors included in each processing unit. In other embodiments, processing unit 904 may also be implemented as a quad-core processing unit formed by integrating two dual-core processors into a single chip.

In various embodiments, processing unit 904 can execute a variety of programs in response to program code and can maintain multiple concurrently executing programs or processes. At any given time, some or all of the program code to be executed can be resident in processor(s) 904 and/or in storage subsystem 918. Through suitable programming, processor(s) 904 can provide various functionalities described above. Computer system 900 may additionally include a processing acceleration unit 906, which can include a digital signal processor (DSP), a special-purpose processor, and/or the like.

I/O subsystem 908 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 900 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 900 may comprise a storage subsystem 918 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 904 provide the functionality described above. Storage subsystem 918 may also provide a repository for storing data used in accordance with the present disclosure.

As depicted in the example in FIG. 9, storage subsystem 918 can include various components including a system memory 910, computer-readable storage media 922, and a computer readable storage media reader 920. System memory 910 may store program instructions that are loadable and executable by processing unit 904. System memory 910 may also store data that is used during the execution of the instructions and/or data that is generated during the execution of the program instructions. Various different kinds of programs may be loaded into system memory 910 including but not limited to client applications, Web browsers, mid-tier applications, relational database management systems (RDBMS), virtual machines, containers, etc.

System memory 910 may also store an operating system 916. Examples of operating system 916 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 900 executes one or more virtual machines, the virtual machines along with their guest operating systems (GOSs) may be loaded into system memory 910 and executed by one or more processors or cores of processing unit 904.

System memory 910 can come in different configurations depending upon the type of computer system 900. For example, system memory 910 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 910 may include a basic input/output system (BIOS) containing basic routines that help to transfer information between elements within computer system 900, such as during start-up.

Computer-readable storage media 922 may represent remote, local, fixed, and/or removable storage devices plus storage media for temporarily and/or more permanently containing, storing, computer-readable information for use by computer system 900 including instructions executable by processing unit 904 of computer system 900.

Computer-readable storage media 922 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 922 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 922 may include, but is not limited to, Zip® drives, flash memory cards, universal serial bus (USB) flash drives, secure digital (SD) cards, DVD disks, digital video tape, and the like. Computer-readable storage media 922 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 900.

Machine-readable instructions executable by one or more processors or cores of processing unit 904 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 924 provides an interface to other computer systems and networks. Communications subsystem 924 serves as an interface for receiving data from and transmitting data to other systems from computer system 900. For example, communications subsystem 924 may enable computer system 900 to connect to one or more devices via the Internet. In some embodiments communications subsystem 924 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 924 can provide wired network connectivity (e.g., Ethernet) in addition to or instead of a wireless interface.

In some embodiments, communications subsystem 924 may also receive input communication in the form of structured and/or unstructured data feeds 926, event streams 928, event updates 930, and the like on behalf of one or more users who may use computer system 900.

By way of example, communications subsystem 924 may be configured to receive data feeds 926 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 924 may also be configured to receive data in the form of continuous data streams, which may include event streams 928 of real-time events and/or event updates 930, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 924 may also be configured to output the structured and/or unstructured data feeds 926, event streams 928, event updates 930, and the like to one or more databases that may be in communication with one or more streaming data source computers coupled to computer system 900.

Computer system 900 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 900 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A method, comprising:
obtaining, by a computing system, requests to be processed, the requests being executed by one or more processing threads running in a background process for a cloud infrastructure service;
receiving, by the computing system, historical information related to the background process for the cloud infrastructure service, the historical information comprising a performance distribution in background process;
evaluating, by the computing system, feasibility to meet an objective for completing the background process based at least in part on the obtained requests and the historical information related to the background process;
determining, by the computing system, an action to take for the background process based at least in part on the evaluation, the action being configured to effect gradual changes in the background process; and
performing, by the computing system, the action for the background process.

2. The method of claim 1, wherein the background process is a first operation being performed in parallel to a second operation performed by the cloud infrastructure service.

3. The method of claim 2, wherein the first operation performed in the background process is a garbage collection operation, and the second operation performed by the cloud infrastructure service is an object deletion operation.

4. The method of claim 1, wherein the performance distribution of the historical information comprises a moving average execution time of the requests by the one or more processing threads over a sliding window.

5. The method of claim 1, wherein the performance distribution of the historical information comprises a trend of changes in a moving average execution time of the requests by the one or more processing threads.

6. The method of claim 1, wherein the objective is an amount of time allowed for the background process to complete the requests assigned to the background process.

7. The method of claim 1, wherein the gradual changes in the background process are changes in an expected execution time for processing the requests to meet the objective, wherein the expected execution time is shorter than and close to the objective while minimum resources are used for the background process.

8. The method of claim 7, wherein the action is an increase, decrease or substantially the same in the expected execution time for processing the requests.

9. A non-transitory computer-readable medium storing computer-executable instructions that, when executed by one or more processors of a computing system, cause the one or more processors to perform operations comprising:
obtaining requests to be processed, the requests being executed by one or more processing threads running in a background process for a cloud infrastructure service;
receiving historical information related to the background process for the cloud infrastructure service, the historical information comprising a performance distribution in background process;
evaluating feasibility to meet an objective for completing the background process based at least in part on the obtained requests and the historical information related to the background process;
determining an action to take for the background process based at least in part on the evaluation, the action being configured to effect gradual changes in the background process; and
performing the action for the background process.

10. The non-transitory computer-readable medium of claim 9, wherein the performance distribution of the historical information comprises a moving average execution time of the requests by the one or more processing threads over a sliding window.

11. The non-transitory computer-readable medium of claim 9, wherein the performance distribution of the historical information comprises a trend of changes in a moving average execution time of the requests by the one or more processing threads.

12. The non-transitory computer-readable medium of claim 9, wherein the objective is an amount of time allowed for the background process to complete the requests assigned to the background process.

13. The non-transitory computer-readable medium of claim 9, wherein the gradual changes in the background process are changes in an expected execution time for processing the requests to meet the objective, wherein the expected execution time is shorter than and close to the objective while minimum resources are used for the background process.

14. The non-transitory computer-readable medium of claim 9, wherein the action is an increase, decrease or substantially the same in the expected execution time for processing the requests.

15. A computing system, comprising:
one or more processors; and
one or more non-transitory computer readable media storing computer-executable instructions that, when executed by the one or more processors of the computing system, cause the computing system to:
obtain, by the computing system, requests to be processed, the requests being executed by one or more processing threads running in a background process for a cloud infrastructure service;
receive, by the computing system, historical information related to the background process for the cloud infrastructure service, the historical information comprising a performance distribution in background process;
evaluate, by the computing system, feasibility to meet an objective for completing the background process based at least in part on the obtained requests and the historical information related to the background process;
determine, by the computing system, an action to take for the background process based at least in part on the evaluation, the action being configured to effect gradual changes in the background process; and
perform, by the computing system, the action for the background process.

16. The computing system of claim 15, wherein the performance distribution of the historical information comprises a moving average execution time of the requests by the one or more processing threads over a sliding window.

17. The computing system of claim 15, wherein the performance distribution of the historical information comprises a trend of changes in a moving average execution time of the requests by the one or more processing threads.

18. The computing system of claim 15, wherein the objective is an amount of time allowed for the background process to complete the requests assigned to the background process.

19. The computing system of claim 15, wherein the gradual changes in the background process are changes in an expected execution time for processing the requests to meet the objective, wherein the expected execution time is shorter than and close to the objective while minimum resources are used for the background process.

20. The computing system of claim 15, wherein the action is an increase, decrease or substantially the same in the expected execution time for processing the requests.
